(19) United States
(12) Patent Application Publication
(10) Pub. No.: US 2008/0109367 A1
(43) Pub. Date: May 8, 2008

(54) Method and apparatus for self-licensing data

(75) Inventor: Oded Shlomo Kraft-Oz, Haifa (IL)

Correspondence Address: DEAN D. SMALL;THE SMALL PATENT LAW GROUP LLP, 611 OLIVE STREET, SUITE 1611, ST. LOUIS, MO, 63101, US

(73) Assignee: GENERAL ELECTRIC COMPANY

(21) Appl. No.: 11/591,770

(22) Filed: Nov. 2, 2006

(51) Int. Cl. G06Q 10/00; H04L 9/00

(52) U.S. Cl. 705/59; 705/1

(57) ABSTRACT

A method for licensing generated data for use with certain advanced software provided by a first software supplier, while allowing use of licensed data with software provided by other software providers includes, for the first software provider, contracting with a user of the generated data to provide a license generator configured to generate a license for the generated data for a fee, and providing advanced software to process licensed data, wherein at least some functionality of the advanced software is available only to licensed data.

### BACKGROUND OF THE INVENTION

This invention relates generally to the control of intellectual property, and more particularly to methods and apparatus for licensing data for use with software providing advanced features for licensed data.

Today, two main forms of software licensing are used. These are:

(1) licensing of software applications based on a license provided upon purchase of the software package. Once a valid license is available, the software functions perpetually. After a customer has purchased the software package, i.e. a license to use it, they can use is perpetually; and

(2) pay per use licensing, where the licensing is perpetual upon receipt, but payments are triggered based on use of the software itself. Each additional use of the software triggers another payment requirement. Pay-per-use is suitable for software packages that are connected online to the internet so the user can be charged. Medical devices used to read and diagnose are many times not connected to the internet due to patient privacy concerns, e.g. HIPAA.

Also, as is well known, different software packages read different file formats. For example, Microsoft Word can read .doc, .txt, and some other types of files, but (to date) cannot read .pdf files that can be read by Adobe Acrobat.

In the medical world, the DICOM Part 10 format is a standard format for distributing medical images. Many freeware and shareware viewers for such data are available on the Internet and provide a range of functionality. The two licensing forms discussed above are generic and do not make use of the fact that in medical imaging (and in some other fields), a file format standard exists. In order to make the studies readable by all viewers, the DICOM Part 10 format must be maintained.

Physicians and hospitals who own equipment used to create studies expect to be able and read those studies anywhere and any time without having to pay repeatedly. Today, it is believed that no solution exists which defines the point of sale to be that of the study creation.

### BRIEF DESCRIPTION OF THE INVENTION

In one aspect, some configurations of the present invention provide a method for licensing generated data for use with certain advanced software provided by a first software supplier, while allowing use of licensed data with software provided by other software providers. The method includes, for the first software provider, contracting with a user of the generated data to provide a license generator configured to generate a license for the generated data for a fee, and providing advanced software to process licensed data, wherein at least some functionality of the advanced software is available only to licensed data.

In another aspect, some configurations of the present invention provide a method for licensing generated data using a computer. The method is for use with certain advanced software provided by a first software supplier, while the method allows use of the licensed data with software provided by other software providers. The method includes, for the first software provider, providing a license generator configured to generate a license for the generated data to produce licensed data, and providing advanced software to process the licensed data, wherein at least some functionality of the advanced software is available only to licensed data.

In yet another aspect, some configurations of the present invention provide a machine readable medium or media on which a set of computer programs or modules is recorded. The programs or modules include instructions configured to instruct one or more computers, either singly or in combination with one another, to generate a license for user-generated data to produce licensed data, and to provide functionality for processing the licensed data, wherein at least some of the functionality is available only to licensed data.

It will be appreciated that some configurations of the present invention provide physicians and hospitals with access to data they created without having to purchase viewing software and without having to pay per view, as may be required when using certain top-of-the-line software applications. However, advanced features are or can be made available when the data is licensed as it is being created or afterwards. More generally, configurations of the present invention allow those producing data to access their data without having to purchase special software or having to pay per use of the special software, but if special software is purchased and the data is licensed, special advanced features can be made available to a user of the data.

### BRIEF DESCRIPTION OF THE DRAWINGS

FIG. 1 is a block diagram showing the generation, use, and licensing of data in a configuration of the present invention.

FIG. 2 is a pictorial block diagram representative of a physical embodiment of the present invention.

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block or random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

### DETAILED DESCRIPTION OF THE INVENTION

As used herein, an element or step recited in the singular and proceeded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

In some configurations of the present invention, a private tag is added to a DICOM Part 10 file, or, more generally, a separate file. The license may be embedded in the data upon the data creation or at a later stage. The added tag is an encrypted sequence of characters that are dependent upon, for example, a study UID (i.e., a unique identifier of a medical study or some other type of study), and/or some other property of the generated data, such as the patient name, the patient ID, the study date and time, and/or other data specific to a study. The added tag may also be based on an external key, such as an ID of a dose used to inject a patient prior to creating the study. Because configurations of the present invention are not limited to medical imaging devices, medical devices per se, imaging devices per se, or DICOM formatted data, many other external keys could be used, either alone or in combination with themselves or other properties of the user-generated data.

Encryption is performed using a private encryption algorithm, i.e., an algorithm with at least some encoding parameters known only to the licensor. The encryption algorithm should be secure, but the encryption algorithm to be used (such as a public/private key encryption algorithm) is a design choice that can be left to one skilled in the art. Any data that contains a valid tag value corresponding to the encrypted sequence and the dependency of the encrypted sequence on, for example, the study UID, is referred to herein as “licensed data.”

Licensed data can be loaded to advanced, top-of-the line applications, which provide value-added advanced features to licensed data. When loaded and a valid license is recognized by the advanced application, advanced features become available. If the data is not licensed (i.e., contains no license or contains an invalid license), then, at the option of the advanced application provider, either none or only a set of basic features is made available. The software package used to provide the top-of-the line features can be made conveniently available by download from an Internet site, for example, and/or supplied on a computer medium or media, such as CD-ROMs, DVDs, floppy diskettes, flash drives, ROMs, hard disks, etc., or any combination of computer media. On the other hand, the ability to create licensed-data can be made available though other means, such as by the advanced application provider offering these rights, at a fee, for any study created (i.e., a perpetual license) or on a pay-per-study-creation basis.

According to the DICOM specification, the private tag can be embedded without damaging the DICOM Part 10 format of a file, so all DICOM supporting devices are able to transport licensed data when sending it from one location to another. Because the DICOM Part 10 format is maintained, freeware, shareware, and other viewers, commercial and non-commercial, are also able to read the user-generated data, with or without embedded license tags, although such viewers will not provide the advanced functionality provided by the advanced application supplied by the licensor.

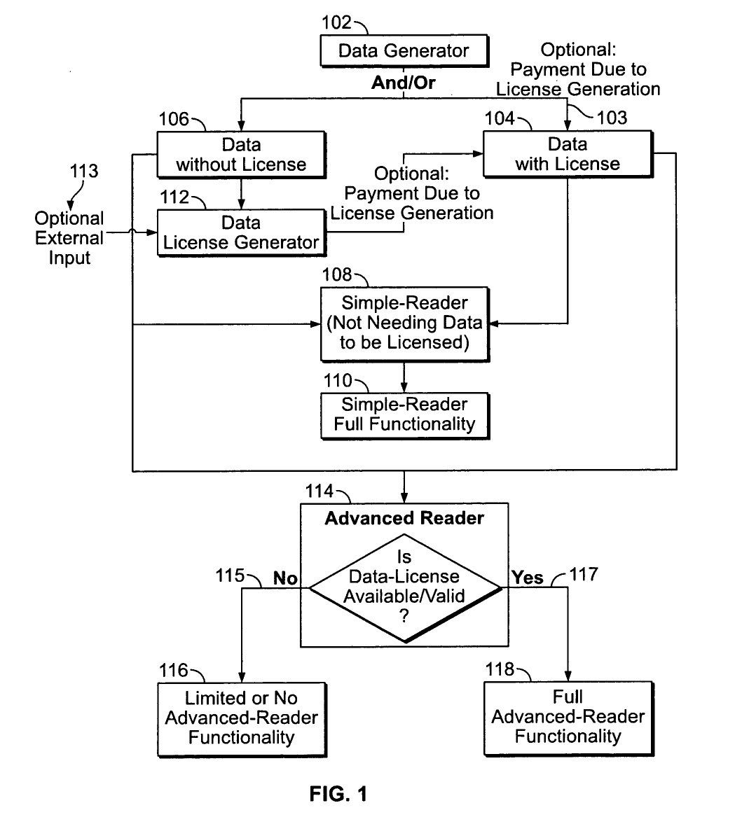

More particularly, in some configurations and referring to FIG. 1, a data generator 102, such as a medical imaging device producing DICOM data, produces data that may or may not include a unique ID and which may or may not be licensed. Whether the generated data is licensed 104 or not 106, it is capable of being read by at least a “simple reader” 108 with full functionality 110 of reader 108. Simple reader 108 may be a third-party reader, and may also be a shareware or freeware reader. Simple reader 108 does not provide all of the features available with full advanced reader functionality. Licensed-data generation 103 or 112 may trigger a payment transaction.

A license generator module 112 is capable of creating a license for the generated data. The license generator may require a proper external input 113 to generate the license. The license is placed within the data in some configurations or external to it in other configurations. License generation may trigger a payment transaction.

In some configurations, a license generator 103 is integrated with data generator 102, while in other configurations, a license generator 112 is external to data generator 102. For example, a reviewer may purchase and receive a license generator 112 and attach licenses to data that was generated without a license. The reviewer's license generator may also generate a license that is stored in the generated data or outside the generated data as a separate file.

A simple reader 108 is a software package that can load and/or process generated data whether that data contains a license or not. Simple reader 108 may be either a free or a purchased software program offered with or without special hardware. Simple reader program 108 is or may be a program licensed perpetually or on a pay-per-use basis, and differs from advanced reader 114 in that it does not rely upon a license contained within the generated data. (Simple reader program 108 may be software from another supplier that provides advanced functionality to some data, but which does not recognize the license contained within the generated data that activates advanced reader 114 to provide advanced functionality.)

Data loaded into simple reader 108 is either licensed data 104 or unlicensed data 106. In either case, the functionality available to process the data is identical because the functionality 110 of simple reader 108 does not depend upon whether there is a license generated by license generator 103 or 112 within the data or not.

An advanced reader 114 is a reader that provides reading and/or processing functionality dependent upon whether the data it processes is licensed by a license generator 103 or 112 or not. If the data is not licensed 115, then either none or only some of the functionality of the advanced reader will be available 116, at the advanced reader supplier's option. In some configurations, advanced reader software 114 attempts to use a license within the data to determine available functionality, but if such a license in not embedded within the data, the advanced reader software may also attempt to use an externally available license to determine whether to provide full functionality. In any case, if a valid license for the data is present 117, the full functionality 118 of advanced reader 114 is made available.

For example, assume that advanced reader 114 has advanced segmentation capabilities. This capability can be made available, at the option of the licensor, only when advanced reader 114 is provided with licensed data 104 and/or when an external license specifically purchased for that functionality is available.

Thus, some configurations of the present invention comprise a method for licensing generated data for use with certain advanced software 114 provided by a first software supplier, while allowing use of the data with simple software 108 provided by other software providers. The method includes, for the first software provider, contracting with a user or producer of generated data to provide a license generator 103 and/or 112 that is configured to generate a license for generated data in return for a fee, and providing advanced software 114 to process data, wherein at least some functionality 118 of the advanced software 114 is available only to licensed data 104. In some configurations, the contract further provides that each use of license generator 103 and/or 112 by the user results in a payment to the first software provider. Further, in some, but not all embodiments of the method, the user of generated data is also the producer of the generated data. Also, in some configurations, license generator 103 is a software module within an imaging device 102.

Imaging device 102, in some configurations, produces DICOM Part 10 formatted images and license generator 103 utilizes encryption to produce an encrypted license code that is dependent upon a property of the generated data, a study number, or both. In some configurations of the present invention, the encrypted license code is a private tag embedded within licensed data 104. See, for example, “Digital Imaging and Communications in Medicine (DICOM) Part 10: Media Storage and File Format for Media Interchange,” copyright 2003 by National Electrical Manufacturers Association, Roslyn, Va., section 7.1, “DICOM File Meta Information” and table 7.1-1, particularly at “Private Information Creator UID” and “Private Information.”

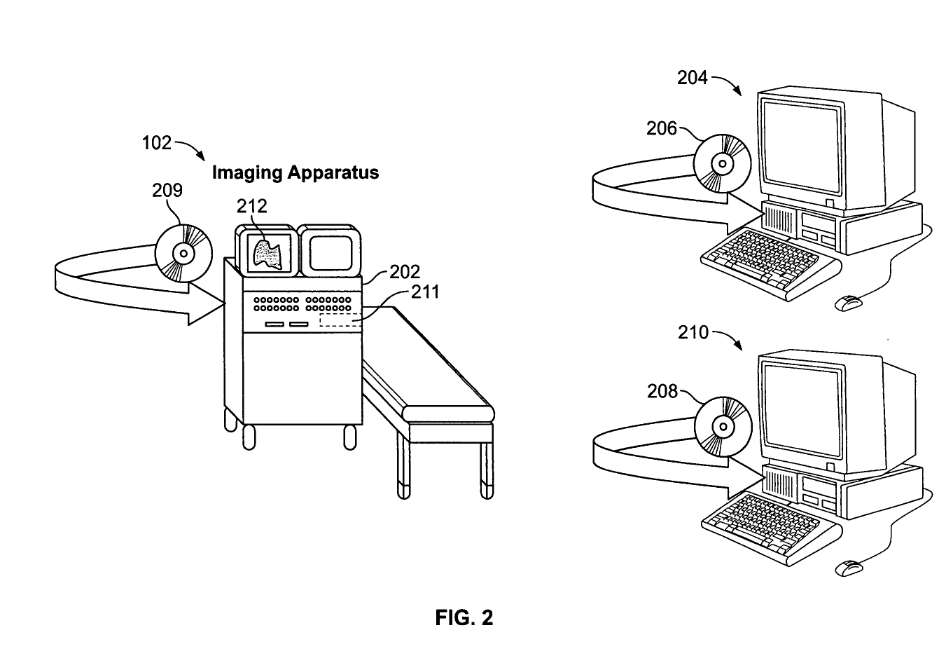

In some configurations of the method, the user of licensed data 106 is someone other than the producer of generated data, so that the user, rather than the producer, may contract for the use of license generator 112. Thus, in some configurations and referring also to FIG. 2, license generator 112 is a software module that runs on a stand-alone or networked workstation 202 other than an imaging device 102 used to produce data. As indicated above, in some configurations of the present invention, the generated data from data generator 102 is in DICOM Part 10 format, and the license is embedded within the licensed data 104, which is also in DICOM Part 10 format.

Also, and referring to FIGS. 1 and 2, some configurations of the present invention provide a method for licensing data produced by a data generator 102 using a computer or processor 202, 204, and/or 210. (The term “computer” is also used herein to refer to a computer or to a processor, however, the term “computer or processor” is used here solely for emphasis.) The method is for use in conjunction with certain advanced software 114 provided by a first software supplier, while the method still allows use of the licensed (or unlicensed) data with simple software 108 provided by other software providers. The method includes, for the first software provider, providing a license generator 103 and/or 112 configured to generate a license for the data, and providing advanced software 114 to process the licensed data, wherein at least some functionality 118 of advanced software 114 is available only to licensed data.

In some configurations of the present invention, license generator 103 is provided as a software module that runs on a processor or computer 202 within an imaging device 102. Imaging device 102 produces DICOM Part 10 formatted images in some configurations, and license generator 103 utilizes encryption to produce an encrypted license code that is dependent upon a property of the generated data, a study number, or both. The encrypted license code is embedded within the generated data in some configurations, and may be embedded as specified by the specification for DICOM Part 10 private data. In some other configurations, license generator 112 is a software module that runs on a stand-alone or networked workstation 204 separate from or outside of imaging device 102.

Referring again to FIGS. 1 and 2, some configurations of the present invention provide a machine readable medium or media 206 and/or 208 and/or 209 on which a set of computer programs or modules is recorded, said programs or modules comprising instructions configured to instruct one or more computers or processors 202, 204, and/or 210 either singly or in combination with one another, to read data with an advanced reader with a license for user-generated data, and provide functionality for processing the user-generated data, wherein at least some of the functionality 118 is available only to licensed data. By “either singly or in combination with one another,” it is meant that the software may be provided in a form in which it instructs a single computer, in which it instructs both computers in combination with one another, or in both forms.

In some configurations, a license generator to generate the license for user generated data is included with instructions configured to instruct an embedded controller 211 within an imaging device 102 or a computer 202 controlling an imaging device to perform imaging tasks, and the functionality for processing said user-generated data includes displaying an image 212 comprising licensed data from the imaging device.

In some configurations, the imaging tasks include producing DICOM Part 10 format images and the license generator utilizes encryption to produce an encrypted license code that is dependent upon a property of the generated data, a study number, or both. Also, in some configurations, the machine-readable instructions include instructions configured to instruct a processor to embed the encrypted license code within the generated data. In some configurations, the instructions configured to generate a license for user-generated data are configured to operate on a computer separate from an imaging device.

It will thus be appreciated that some configurations of the present invention provide physicians and hospitals with access to data they created without having to purchase viewing software and without having to pay per view, as may be required when using certain top-of-the-line software applications. However, advanced features are or can be made available when the data is licensed as it is being created or afterwards. More generally, configurations of the present invention allow those producing data access to their data without having to purchase special software or having to pay per use of the special software, but if special software is purchased and the data is licensed, special advanced features can be made available to a user of the data.

While the invention has been described in terms of various specific embodiments, those skilled in the art will recognize that the invention can be practiced with modification within the spirit and scope of the claims.

What is claimed is:

1. A method for licensing generated data for use with certain advanced software provided by a first software supplier, while allowing use of licensed data with software provided by other software providers, said method comprising, for the first software provider:
contracting with a user of said generated data to provide a license generator configured to generate a license for said generated data for a fee; and
providing advanced software to process licensed data, wherein at least some functionality of said advanced software is available only to licensed data.

2. The method of claim 1 wherein the contract provides that each use of the license generator by the user results in a payment to the first software provider.

3. The method of claim 1 wherein the user of said licensed data is the producer of said licensed data.

4. The method of claim 3 wherein the license generator is a software module that runs on a processor embedded within an imaging device.

5. The method of claim 4 wherein the imaging device produces DICOM Part 10 format images and the license generator utilizes an encryption generator to produce an encrypted license code that is dependent upon a property of the generated data, a study number, or both.

6. The method of claim 1 wherein the encrypted license code is embedded within the generated data to form the licensed data.

7. The method of claim 1 wherein the user of said licensed data is someone other than the producer of said generated data.

8. The method claim 7 wherein the license generator is a software module that runs on a stand-alone or networked workstation separate from an imaging device.

9. The method of claim 8 wherein the generated data is in DICOM Part 10 format.

10. The method of claim 9 wherein the license is embedded within the generated data so that the licensed data is in DICOM Part 10 format.

11. A method for licensing generated data using a computer, said method for use with certain advanced software provided by a first software supplier, while allowing use of the licensed data with software provided by other software providers, said method comprising, for the first software provider:
providing a license generator configured to generate a license for said generated data to produce licensed data; and
providing advanced software to process said licensed data, wherein at least some functionality of said advanced software is available only to licensed data.

12. The method of claim 11 wherein the license generator is a software module that runs on a processor embedded within an imaging device.

13. The method of claim 12 wherein the imaging device produces DICOM Part 10 format images and the license generator utilizes encryption to produce an encrypted license code that is dependent upon a property of the generated data, a study number, or both.

14. The method of claim 13 wherein the encrypted license code is embedded within the licensed data, so that the licensed data is also in DICOM Part 10 format.

15. The method of claim 14 wherein the license generator is a software module that runs on a stand-alone or networked workstation other than an imaging device.

16. A machine readable medium or media on which a set of computer programs or modules is recorded, said programs or modules comprising instructions configured to instruct one or more computers, either singly or in combination with one another, to:
read a license for user-generated data to produce licensed data; and
provide functionality for processing said licensed data, wherein at least some of said functionality is available only to licensed data.

17. The machine readable medium or media of claim 16 wherein a license generator to generate said license for user generated data is included with instructions configured to instruct an embedded controller within an imaging device or a computer controlling an imaging device to perform imaging tasks, and the functionality for processing said user-generated data includes displaying an image comprising licensed data from the imaging device.

18. The machine readable medium or media of claim 17 wherein said imaging tasks include producing DICOM Part 10 format images and the license generator utilizes an encryption generator to produce an encrypted license code that is dependent upon a property of the generated data, a study number, or both.

19. The machine readable medium or media of claim 18 wherein the machine readable instructions include instructions configured to instruct a processor to embed the encrypted license code within the generated data to produce DICOM Part 10 format images containing an embedded license.

20. The machine readable medium or media of claim 16 wherein said instructions configured to generate a license for user-generated data is configured to operate on a computer separate from an imaging device.
